(19) United States
(12) Patent Application Publication
(10) Pub. No.: US 2007/0139018 A1
(43) Pub. Date: Jun. 21, 2007

(54) BACK UP POWER SUPPLY

(75) Inventor: Richard Mentelos, Guilford, CT (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: RAM Technologies LLC, Guilford, CT (US)

(21) Appl. No.: 11/608,858

(22) Filed: Dec. 11, 2006

Related U.S. Application Data
(60) Provisional application No. 60/750,720, filed on Dec. 15, 2005.

(51) Int. Cl. H02J 7/00

(52) U.S. Cl. 320/166

(57) ABSTRACT

A device, system and method for a backup power supply are disclosed herein. The backup power supply may use at least one ultra capacitor to store a voltage. The backup power supply may also have a multiphase boost converter to provide a relatively constant voltage from the stored voltage and a constant changing power filter to regulate a current that is used to charge the ultra capacitor. A charging and discharging controller may be used to monitor the status of a power supply and control the charging and discharging of the ultra capacitors.

### CROSS-REFERENCE TO RELATED APPLICATIONS

This application claims priority to U.S. patent application No. 60/750,720 filed Dec. 27, 2005 entitled BACKUP POWER SUPPLY, which is incorporated fully herein by reference.

### TECHNICAL FIELD

The present invention relates to a backup power supply and more particularly, relates to backup power supply using one or more capacitors.

### BACKGROUND INFORMATION

Power supplies, often referred to as “switching power supplies,” use switcher technology to convert the AC input to lower DC voltages. Over time, there have been at least six different standard power supplies for use with computer hardware. ATX is an industry specification that means the power supply has the physical characteristics to fit a standard ATX case and the electrical characteristics to work with an ATX motherboard.

A backup power is a power supply that keeps the computer hardware and software operating in the event of a power outage. Most backup power supplies serve as advanced surge protectors, which keep the hardware and software running for a few minutes until the hardware may safely be shut down or until a backup generator or other source resumes providing power. The backup power supplies may operate on a chargeable battery that will make sure that the power to hardware is uninterrupted.

Lead acid chargeable batteries may last about 2-4 years depending on environmental conditions like temperature, cycle use, and other variables. Recently Lithium Polymer chargeable batteries have entered the market but they lack internal impedance and have similar life expectancies. Accordingly, a need exists for a device, method, and system that can provide a reliable source for providing power.

### BRIEF DESCRIPTION OF THE DRAWINGS

These and other features and advantages of the present invention will be better understood by reading the following detailed description, taken together with the drawings wherein:

FIG. 1 is a block diagram of a backup power supply according to a first exemplary embodiment of the invention.

FIG. 2 is a schematic of a circuit implementing the backup power supply according to a second exemplary embodiment of the invention.

FIG. 3 is a flowchart of an exemplary backup power supply embodiment method according to the present invention.

### DETAILED DESCRIPTION

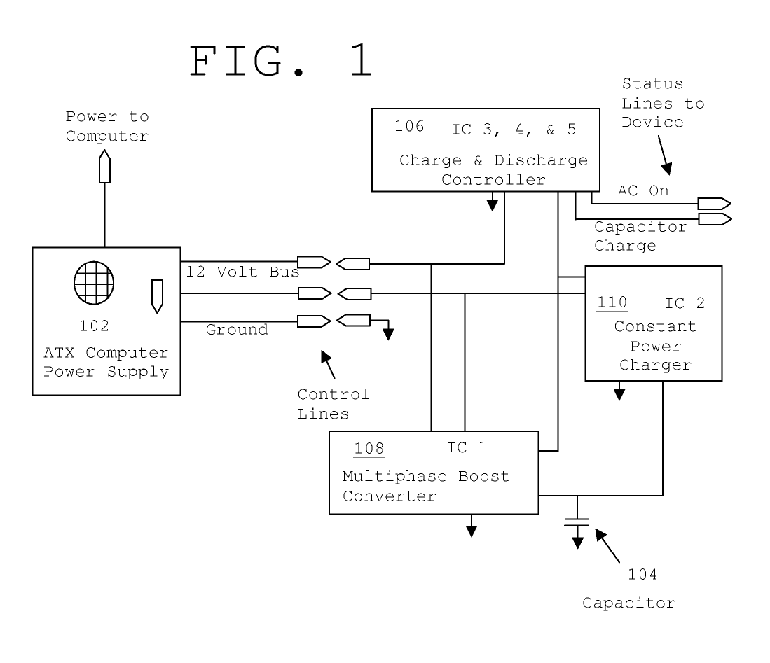

FIG. 1 is a flowchart of a backup power supply 100 according to a first exemplary embodiment of the invention. The backup power supply provides power to a hardware power supply 102 when the main source of power supplied to the hardware power supply is interrupted. The backup power supply 100 uses one or more capacitors 104 to store and supply secondary power when the main power source of the hardware power supply 102 is interrupted. During normal operating conditions when the main power source is supplying power to the hardware power supply 102, the backup power supply 100 receives power from the hardware power supply to charge and maintain the capacitors 104 in a charged state. This may be referred to as a charging cycle and will be discussed in greater detail later herein. When the main source of power supplied to the hardware power supply 102 is interrupted, the backup power supply 100 goes into a discharging cycle and supplies a secondary source of power to the hardware power supply 100 by discharging the capacitors 104. Details regarding the components and charging and discharging processes are discussed in greater detail later herein.

Referring to FIG. 1, the hardware power supply 102 receives AC power from the main power source, for example, a utility outlet. The hardware power supply 102 converts the Alternating Current (AC) power to Direct Current (DC) power that is used to supply power to the intended hardware. The hardware power supply 102 may provide a 12-volt bus, a ground, and one or more control lines to the backup power supply 100. The control lines provide the status of the main power source supply to both a backup power controller 106 and a multiphase boost converter 108. The 12-volt bus provides power to components of the backup power supply during the charging cycle and receives power from the backup power supply during the discharging cycle.

The capacitor 104 may be super capacitors or ultra capacitors. The ultra capacitors may use two sheets of aluminum foil and a separator. The electric charge is stored on the aluminum foil surface. The ultra capacitors use a structure of aluminum foil (current collector) coated with carbon powder (electric charge storage). With a surface area of up to about 2000 square meters per gram of carbon, significant charge storage is possible. Externally, cylindrical ultra capacitors may use the same structure as electrolytic capacitors. The ultra capacitors may be a “BCAP” series ultra capacitors manufactured by Maxwell Technologies of San Diego, Calif. Another example may include an electronic double layer capacitors manufactured by United Chemi-Con (UCC) of Rosemont, ill. The above are examples of ultra capacitors. It will be apparent to an individual skilled in the art that a variety of ultra capacitors from various manufactures may be used to implement embodiments of the invention.

The backup power controller 106 regulates the charging and discharging cycles of the one or more capacitors 104. The backup power controller 106 monitors the status of both the AC power source and the status of the one or more capacitors 104. Based on this status information received by the backup power controller 106, the controller 106 regulates the charging and discharging of the capacitors 104.

If the main power source is currently supplying power to the hardware power supply 102, the controller 106 signals to a power charger 110 to continue to supply power from the 12-volt bus to the capacitors 104, thus charging and/or maintaining the capacitors 104 in a charged state. Because the capacitors 104 may have extremely low internal impedance, which may be independent of their charged state, the capacitors 104 may accept as much current as the power supply provides. In addition, the capacitors 104 may be sensitive to voltages greater than their ratings. The power charger 110 may need to limit the voltage in a precise manner. The power charger 110 may need to be designed to a variety of conditions required by various capacitors.

If the main power source is interrupted, the controller 106 signals the multiphase boost converter 108 to start draining power from the capacitors 104 and supply power to the hardware power supply 102 via the 12-volt bus. The multiphase boost converter 108 may need to supply a relatively constant voltage using the power stored in the capacitors 104 that supply power over a range of voltages. The multiphase boost converter may need to be an efficient design. The multiphase boost converter 108 may be a two-phase boost converter as discussed in an exemplary embodiment discussed later herein. The multiphase boost converter 108 may also be a single phase or use additional phases to provide additional efficiency, for example, a four-phase boost converter may be used. Depending on the capacitors 104 used and the desired efficiency, the boost converter 108 may use a variety of designs and configurations as are apparent to an individual skilled in the art.

A capacitor may store energy over an entire range of voltages; thus the energy may need to be extracted by discharging to the lowest possible voltage. A characteristic of the boost converter 108 is that the output voltage may be greater than the input voltage. One may also use a “buck” type converter but may only discharge the capacitor to the desired output voltage, which may leave unused energy in the capacitor. Due to the design of a “buck” converter, the output may have to be less than the input. However a “buck-boost” type converter may allow the output voltage to be above and below the input. The “buck-boost” type converter may allow a greater voltage range on the capacitor. The “buck-boost” or a polyphase “buck-boost” converter may be limited by the design of the “buck-boost” converter.

The backup power controller 106 may also monitor the output voltage of the multiphase boost converter 108. When the voltage output of the multiphase boost converter 108 drops below a predetermined threshold, the controller 106 may shut down the backup power supply 100 in order to avoid damage to the backup power supply 100 and/or the hardware that is being supplied with power. The controller 106 may remain in a tripped state until reset. The reset may occur when the controller 106 receives a signal that the power supplied to the main power supply has been reestablished. Once the controller 106 is reset, the cycle of charging and discharging is continued.

In addition to controlling the components of the backup power supply 100, the controller 106 may also signal the hardware directly or via the hardware power supply the status of the backup power supply 100. The backup power supply 100 according to the exemplary embodiment of the block diagram in FIG. 1 illustrates the backup power supply as being separate from the hardware power supply, however, another exemplary embodiment of the invention may implement the backup power supply 100 and the hardware power supply as a single unit. Although the various components are grouped together for illustrative purposes according to the block diagram of FIG. 1, the invention is not limited to the configuration of the illustrative block diagram. Components may be added or substituted to perform various tasks of the invention.

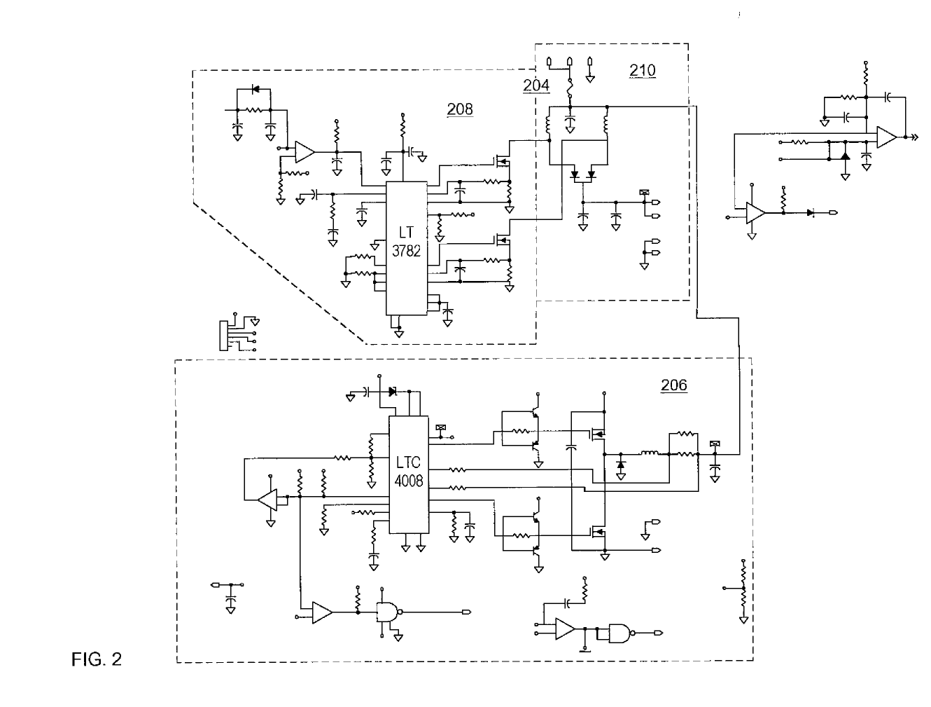

Referring to FIG. 2, a circuit diagram of a backup power supply 200 according to a second exemplary embodiment of the invention may be used to implement the first exemplary embodiment. It will be apparent to individuals skilled in the art that other circuit configurations may be used to implement features of the invention. A backup power supply circuit provides backup power to a hardware power supply (not shown). The hardware power supply may be an ATX power supply or other form factor of the FX series. The hardware power supply is not limited to any specific form factor. The backup power supply circuit uses one or more capacitors 204 to store and supply secondary power when the main power source of the hardware power supply is interrupted. The backup supply circuit may use four 2.5 volt, 400 farad ultra capacitors in series to supply a total of 10 volts. During normal operating conditions when the main power source is supplying power to the hardware power supply, the backup power supply receives power from the hardware power supply to charge and maintain the capacitors in a charged state. This may be referred to as a charging cycle and will be discussed in greater detail later herein. When the main source of power supplied to the hardware power supply is interrupted, the backup power supply goes into a discharging cycle and supplies a secondary source of power to the hardware power supply by discharging the capacitors. Details regarding the components and charging and discharging processes are discussed in greater detail later herein.

Referring to FIG. 2, the hardware power supply may provide a 12-volt bus, a ground, and one or more control lines to the backup power supply. The control lines provide the status of the main power source supply to both a backup power controller 206 and a multiphase boost converter 208. The 12-volt bus provides power to components of the backup power supply during the charging cycle and receives power from the backup power supply during the discharging cycle.

The backup power controller regulates the charging and discharging cycles of the capacitors. The backup power controller monitors the status of both the AC power source with an AC power monitoring circuit and the status of the one or more capacitors with a charge monitoring circuit. Based on this status information received by the backup power controller, the controller regulates the charging and discharging of the capacitors.

If the main power source is currently supplying power to the hardware power supply, the controller signals to a power charger to continue to supply power from the 12-volt input terminal to the capacitors, thus charging and/or maintaining the capacitors in a charged state. A power charger 210 regulates the current supplied to the capacitors during the charging process. If the main power source is interrupted, the controller signals the multiphase boost converter to start draining power from the capacitors and supply power to the hardware power supply via the 12-volt terminal. The multiphase boost converter may need to supply a relatively constant voltage using the power stored in the capacitors that supply power over a range of voltages. The multiphase boost converter may be a two-phase boost converter with a first phase and a second phase operating 180 degrees out of phase from the first phase.

The backup power controller may also monitor the output voltage of the multiphase boost converter with a shutoff circuit. When the voltage output of the multiphase boost converter drops below a predetermined threshold, the controller may shut down the backup power supply in order to avoid damage to the backup power supply and/or the hardware that is being supplied with power. The controller may remain in a tripped state until reset. The reset may occur when the controller receives a signal that the power supplied to the main power supply has been reestablished. Once the controller is reset the cycle of charging and discharging is continued. The invention is not limited to the configuration of the circuit components shown in the exemplary embodiment shown in FIG. 2. A variety of configurations for the exemplary circuit shown in FIG. 2 may be added or substituted.

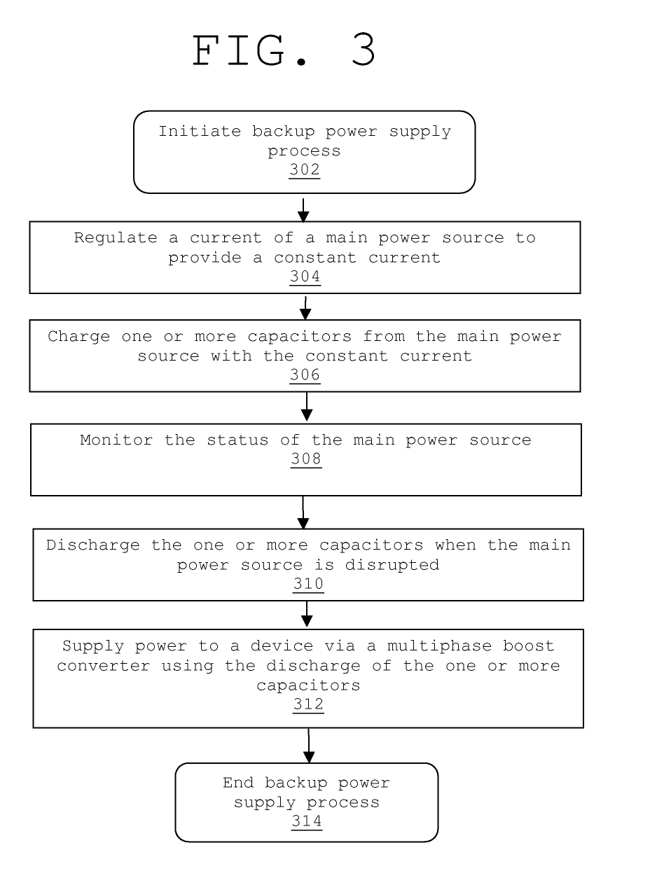

Referring to FIG. 3, an exemplary backup power supply method 300 supplies temporary power to a device. The device may be, for example, a power supply, a desktop computer, a server or other processor and memory that may require a temporary source of power. The backup power supply method may be initiate when the device is activated (block 302). The method is not limited to being initiated by activation of the device; for example, the backup power supply may be initiated anytime a source of power is supplied to the backup power supply. The current is regulated to provide a constant current source from main power source, which may be AC (block 304). The current is supplied to one or more capacitors and is used to charge the capacitors to a charged state (block 306).

A controller monitors the status of the main power source (block 308). The monitoring may be accomplished by a controller within the backup power supply or by a remote device that may signal the backup power supply of an impending disruption of the main power. The disruption may be a drop in power or a spike that may require the main power supply to be interrupted. Once a disruption has been detected the backup power supply switches from a charging state to a discharging state. The one or more capacitors are drained of their stored power (block 310). A multiphase boost converter uses the variable voltage supplied by the discharging capacitors and converts the power to a power source with constant voltage that may be used by the device (block 312). The device may use the backup power to perform critical functions, for example, but not limited shutting down operations or switching to another power source. The controller may also monitor the discharging voltage of the capacitors to prevent damage resulting from too low of voltage. Once the voltage drops below a point the backup power supply may be completely shutoff to prevent device to the backup power supply and/or the device being supplied power. The process may be completed and wait for the main power supply to re-supply the backup power supply with power or for reset by an administrator. Aspects of the exemplary backup power supply process may be performed by a dedicated controller within the backup power supply or by an ancillary processor that may be a part of the device being supplied power.

Modifications and substitutions by one of ordinary skill in the art are considered to be within the scope of the present invention, which is not to be limited except by the following claims.

The invention claimed is:

1. A backup power supply comprising:
one or more capacitors for storing a voltage;
a multiphase boost converter for providing a relatively constant voltage from the stored voltage of the one or more capacitors;
a constant changing power filter for regulating a current that is used to charge the one or more capacitors; and
a charging and discharging controller for monitoring a status of a power supply and regulating the charging and discharging of the one or more capacitors.

2. The power supply of claim 1, wherein each capacitor is rated for between about 3 to 10 volts.

3. The power supply of claim 1, wherein the multiphase boost converter is a buck boost converter.

4. The power supply of claim 1, wherein the backup power supply is for an ATX computer power supply.

5. The power supply of claim 1, wherein the one or more capacitors are charging during normal operation of a device being supplied power.

6. The power supply of claim 1, wherein the charging and discharging controller signals a device being supplied power when a switch between charging and discharging occurs.

7. The power supply of claim 1, wherein the charging and discharging controller shuts off the voltage supplied by the one or more capacitors when the voltage supplied by the one or more capacitors drops below a predetermine voltage.

8. A backup power supply for a computer power supply comprising:
at least one ultra capacitor for storing a voltage from a AC power source and supplying a DC power supply for a computer;
a multiphase boost converter for providing a constant voltage from the stored voltage;
a constant changing power filter for regulating a current that is used to charge the ultra capacitor; and
a charging and discharging controller for monitoring a status of a power supply, maintaining the at least one ultra capacitor in a charged state during a normal operation period, and draining the at least one ultra capacitor during a backup operation period.

9. The backup power supply of claim 8, wherein each capacitor is rated for between about 3 to 10 volts.

10. The backup power supply of claim 8, wherein the multiphase boost converter is a buck boost converter.

11. The backup power supply of claim 8, wherein the backup power supply is housed within an ATX computer power supply.

12. The backup power supply of claim 8, wherein the one or more capacitors are charging during normal operation a device being supplied power.

13. The backup power supply of claim 8, wherein the charging and discharging controller signals the computer being supplied power when a switch between charging and discharging occurs.

14. The backup power supply of claim 8, wherein the charging and discharging controller shuts off the voltage supplied by the one or more capacitors when the voltage supplied by the one or more capacitors drops below a predetermine voltage.

15. A method for supplying backup power comprising the actions of:
regulating a current of an AC power source to provide a constant current;
charging one or more ultra capacitors from the AC power source with the constant current;
monitoring the status of the AC power source;
discharging the one or more ultra capacitors when the AC power source is disrupted; and
supplying power with a constant voltage to a device via a multiphase boost converter using the discharge of the one or more ultra capacitor.

16. The method for supplying backup power of claim 15, wherein each ultra capacitors is rated for between about 3 to 10 volts.

17. The method for supplying backup power of claim 15, wherein the multiphase boost converter is a buck boost converter.

18. The method for supplying backup power of claim 15, wherein the device is a computer.

19. The method for supplying backup power of claim 15, further comprising the actions of:
signaling the device being supplied power when a switch between charging and discharging the one or more ultra capacitors occurs.

20. The method for supplying backup power of claim 15, further comprising the actions of:
shutting-off the one or more capacitors when a voltage supplied during discharging the one or more ultra capacitors drops below a predetermine voltage.
